(19) United States
(12) Patent Application Publication
(10) Pub. No.: US 2012/0043393 A1
(43) Pub. Date: Feb. 23, 2012

(54) Fuel Injector with Damper Volume and Method for Controlling Pressure Overshoot

(75) Inventors: Zhenyu Li, Peoria, IL (US); Alan Stockner, Metamora, IL (US)

(73) Assignee: CATERPILLAR, INC., Peoria, IL (US)

(21) Appl. No.: 12/857,765

(22) Filed: Aug. 17, 2010

(51) Int. Cl. F02M 63/00

(52) U.S. Cl. 239/5; 239/533.2

(57) ABSTRACT

A fuel injector configured to inject a predetermined volume of fuel, such as heavy fuel oil, is disclosed. The disclosed injector includes an injector body that defines a fuel inlet, a fuel passageway, and an orifice. The injector also includes a needle disclosed at least partially within the injector body. The needle is movable between a closed position where the needle blocks the orifice and an open position where the needle at least partially unblocks the orifice. At least the injector body and the needle define a nozzle chamber. The nozzle chamber is in communication with a high pressure fuel passageway and the orifice. The fuel passageway and nozzle chamber have a combined volume greater than the predetermined injection volume. The combined volume of the nozzle chamber and fuel passageway act as a damper to alleviate the effects of pressure overshoot, pressure oscillations and water hammer

### TECHNICAL FIELD

This disclosure relates generally to a system and method for reducing pressure oscillations in a fuel injector for an engine. More specifically, a volume of fuel in a nozzle chamber and at least part of a high-pressure fuel line leading to the nozzle chamber is used as a damper for reducing the effects of pressure overshoot, pressure oscillations and the phenomenon known as “water hammer.”

### BACKGROUND

In many fuel injectors, a simple spring biased needle check valve is used to open and close the nozzle outlet. The needle typically includes at least one hydraulic surface that is acted upon by fuel pressure. A compression spring is positioned to bias the needle toward its closed position. When fuel pressure rises above a pressure sufficient to overcome the spring, the needle lifts to open the nozzle outlet to commence an injection event. Each injection event ends when fuel pressure drops below a pressure necessary to keep the needle open against the biasing action of spring. When this occurs, the spring pushes the needle downward to its closed position to end the injection event.

An improvement on the simple spring biased needle is commonly known as a trapped volume nozzle. In a typical fuel injector employing a trapped volume nozzle, the compression biasing spring and one end of the needle are positioned in a closed volume space. During an injection event, high-pressure fuel migrates up the outer guide surface of the needle into the trapped volume. Displacement of the needle into the trapped volume compresses fuel in the trapped volume. These two phenomena raise pressure in the trapped volume to relatively high pressures, which sometimes are in excess of 20 MPa. The purpose of the trapped volume is to increase the speed at which the needle moves to its closed position at the end of an injection event. Those skilled in the art are well aware that in most instances it is desirable to make an injection event end as abruptly as possible in order to decrease undesirable noise and improve emissions from the engine. The trapped volume nozzle achieves this goal by having the needle pushed toward its closed position at the end of an injection event not only by the force of the biasing spring but also by a hydraulic force due to the fluid pressure in the trapped volume that acts on one end of the needle.

Marine engines commonly operate on heavy fuel oil (HFO), which has a very high bulk modulus (1200 MPa at vacuum; 3145 MPa at 200 MPa). The high bulk modulus of HFO may lead to pressure overshoot and pressure oscillation problems. Specifically, in high-pressure fuel injection systems, when an injection through the nozzle is stopped, pressures in the high-pressure plumbing circuit can increase significantly above the nominal pressure levels. The pressure increase results from a sudden change in momentum of the inbound HFO. The change in momentum of the HFO creates pressure oscillations due to its high bulk modulus. The pressure oscillations are commonly known as “water hammer”. Water hammer is undesirable because the resulting high-pressure levels in the fuel injection injector can shorten the operating life of the injector and promote injector failure. Such oscillations also create difficulties in governing the quantity and timing of fuel delivered in multiple injections. In addition to HFO, other fuels such as diesel and gasoline generate water hammer effects.

### SUMMARY OF THE DISCLOSURE

In one aspect, a fuel injector is disclosed that injects a predetermined volume of fuel. The injector includes an injector body that defines a fuel inlet and a fuel passageway. The injector body may be connected to a nozzle tip that includes an orifice. A needle is disposed at least partially within the nozzle tip. The needle is movable between a closed position where the needle blocks the orifice and an open position where the needle at least partially unblocks the orifice. At least the nozzle tip and the needle define a nozzle chamber. The nozzle chamber is in communication with a fuel passageway and the orifice. The fuel passageway and nozzle chamber have a combined volume that is greater than the predetermined volume. The combined volumes of the fuel passageway and nozzle chamber act as a liquid spring or damper for reducing the effects of pressure overshoot, pressure oscillations and water hammer.

In another aspect, a fuel injector is disclosed that is configured to inject a predetermined volume of heavy fuel oil (HFO). The fuel injector includes an injector body that defines a fuel inlet and a fuel passageway. The injector body may be connected to a nozzle tip that includes an orifice. A needle is disposed at least partially within the nozzle tip. The needle is movable between a closed position where the needle blocks the orifice and an open position where the needle at least partially unblocks the orifice. At least the nozzle tip and needle define a nozzle chamber. The nozzle chamber is in communication with the fuel passageway and the orifice. The fuel passageway and the nozzle chamber have a combined volume that ranges from about 15 to about 30 times greater than the predetermined injection volume.

A method for reducing pressure overshoot in a fuel injection system is also disclosed. The method includes providing an injector body that defines a nozzle chamber and a fuel passageway. The injector body may be connected to a nozzle tip that includes an orifice. The method further includes providing a needle disposed at least partially within the injector body. The needle is movable between a closed position where the needle blocks the orifice and an open position where the needle at least partially unblocks the orifice. The method further includes providing a nozzle chamber defined at least by the nozzle tip and the needle. The nozzle chamber is in communication with the fuel passageway and the orifice. The fuel passageway and the nozzle chamber have a combined volume ranging from about 10 to about 30 times greater than the predetermined injection volume. Providing the combined volume of the fuel passageway and nozzle chamber provides a liquid spring or dampening effect for reducing the effects of pressure overshoot, pressure oscillations and water hammer caused by operation of the fuel injector.

Preferably, in any one or more of the injectors or method described above, the combined volume of the nozzle chamber and high pressure fuel line is at least 10 times the predetermined fuel dispense volume. More preferably, in any one of the fuel injectors or method described above, the combined volume is at least greater than 15 times the predetermined volume. Still further, in any one of the fuel injectors or method described above, the combined volume may range from about 15 to about 30 times the predetermined fuel injection volume. In any one of the fuel injectors or method described above, the fuel passageway may have a substantially continuous diameter. In any one of the fuel injectors or method described above, the nozzle tip and needle may define the nozzle chamber that surrounds the needle and that is connected to the fuel passageway. In any of the fuel injectors or method described above, the needle may be connected to a stop for limiting upward movement of the needle. In any of the fuel injectors or methods described above, the stop may engage a shim when the needle is open. In any of the fuel injectors or methods described above, the stop, nozzle tip and shim may form a clearance that enables the needle and control valve to move between the open and closed positions. In any of the fuel injectors or method described above, the fuel injector may be configured to inject heavy fuel oil (HFO). If HFO is injected, it may have a bulk modulus of at least 3000 MPa at a pressure of about 200 MPa. In either of the fuel injectors or method described above, the predetermined injection volume may range from about 10 to about 20 mL, more preferably from about 13 to about 17 mL.

### BRIEF DESCRIPTION OF THE DRAWINGS

FIG. 1 is a front and sectional view of a disclosed fuel injector;

FIG. 2 is an enlarged view of the fuel injector shown in FIG. 1, particularly illustrating the needle and orifice;

FIG. 3 graphically illustrates pressure fluctuations (y-axis) caused by injecting HFO through a conventional injector;

FIG. 4 graphically illustrate the reduced pressure fluctuations (y-axis) resulting from injecting HFO using a disclosed injector; and

FIG. 5 graphically illustrates pressure fluctuations (y-axis) as a function of the ratio of the nozzle chamber and fuel passageway volume over the injected fuel quantity.

### DETAILED DESCRIPTION

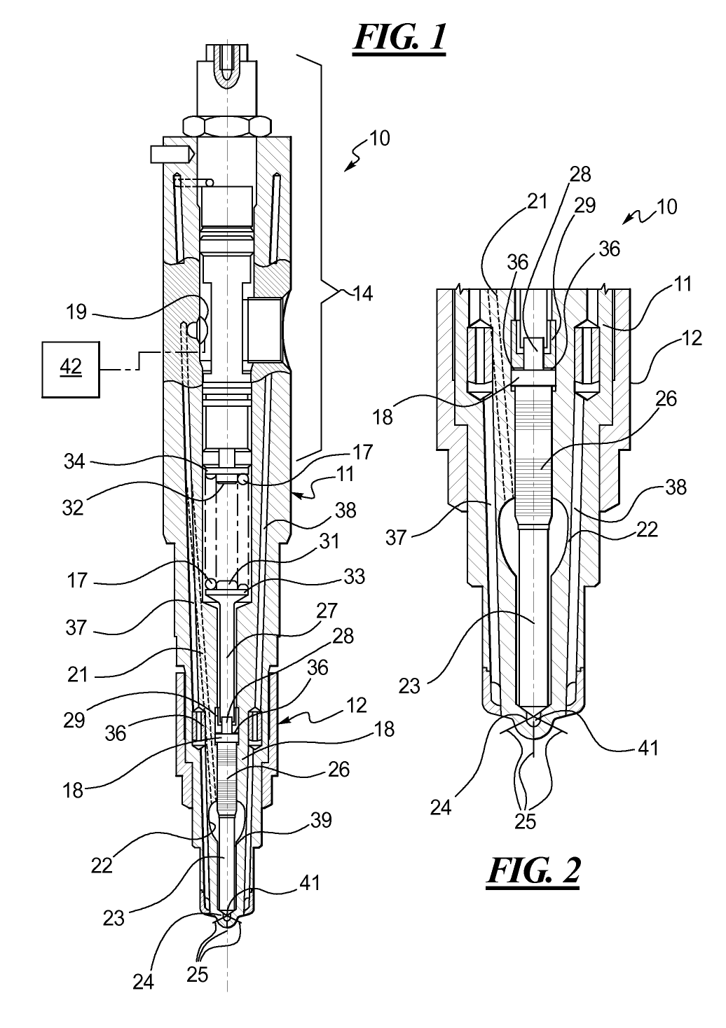

Referring to FIG. 1, a fuel injector 10 is shown that is equipped with an injector body 11, nozzle casing 12 and a nozzle tip 13. Fuel enters the injector 10 through the inlet 19 that is in communication with the fuel pump and ECM (not shown). A spring pre-load assembly 14 provides the correct downward bias for the spring 17. High-pressure fuel is provided by a pump or other device (not shown) before it enters the inlet 19 and proceeds down through the high-pressure fuel passageway 21. The high-pressure fluid passageway 21 leads to the nozzle chamber 22. The nozzle chamber 22 is defined at least in part by the injector body 11 or nozzle tip 13 and the needle 23. The needle 23 is shown in the closed position, seated against the valve seat 24, which includes a plurality of orifices 25. The needle 23 is connected to a needle grooved section 26, which can retain lubricant in the microgrooves shown. The grooved section 26 is coupled to a needle stop portion 18 and a top of needle 28, which, in turn, passes through a shim 29. The top of needle 28 and shim 29 are coupled to a piston 27. The spring 17 is held in place by the piston top 31, push pin 32 and the piston flange 33 and push pin flange 34, which may form part of the piston 27 and spring-load assembly 14 respectively.

In the position shown in FIGS. 1 and 2, the needle 23 is seated against the valve seat 24 and therefore the injector 10 is closed. To open the needle 23, pressure is supplied through the high-pressure fuel line 21 and in the nozzle chamber 22. High pressure in the nozzle chamber 22 causes the needle piston 23 to move upwards and needle stop portion 18 to consume the clearance shown at 36 thereby lifting the needle 23 off of the seat 24 and exposing the orifices 25 to high pressure fuel in the chamber 22 which migrates downward through the annular space 39 towards the orifices 25. Cooling passages are shown at 37, 38.

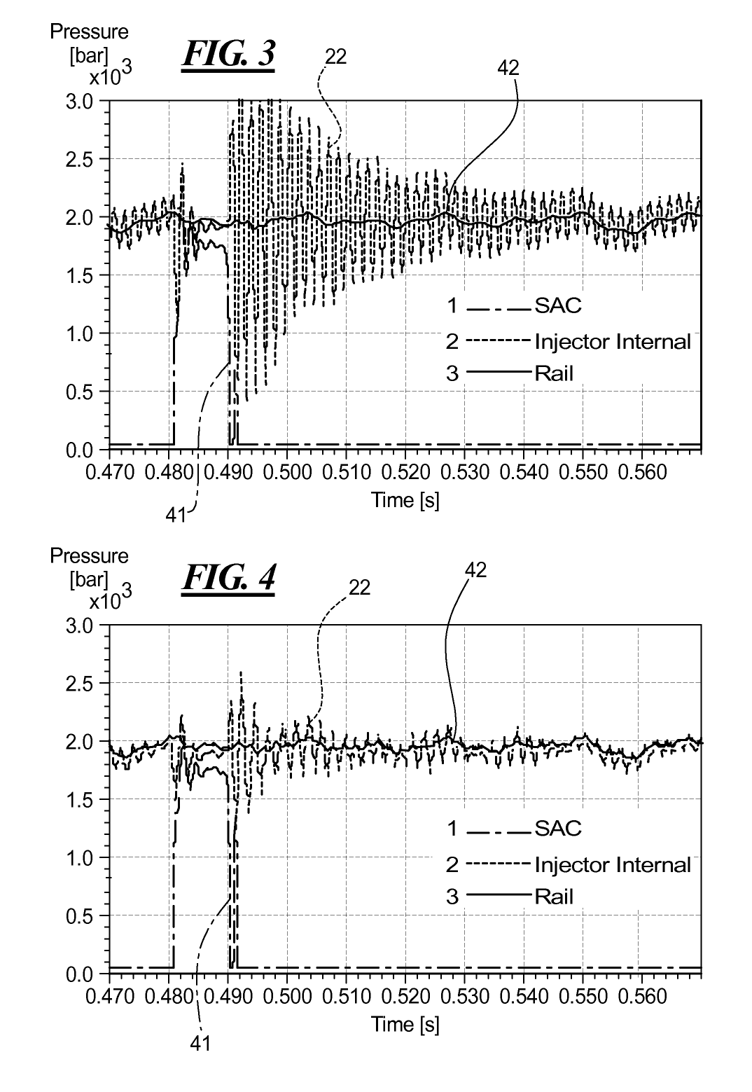

The problem addressed by the disclosed fuel injector 10 is the reduction of pressure overshoot and oscillation, also known as “water hammer”. At high pressure, a fuel injector's trapped volume can be thought of as a liquid spring where the liquids bulk modulus represents the spring rate and the liquids volume represents the spring mass. Fuel injectors with small nozzle chambers 22 or nozzle chambers 22 that are not much larger than the actual volume of dispensed fuel suffer from pressure oscillations, pressure overshoot and water hammer Specifically, turning to FIG. 3, pressure readings are taken in three places: the sac volume 41 (See FIGS. 1-2), a point internal to the injector body 11 such as the nozzle chamber 22 and the fuel supply 43 (FIG. 1). As can be seen from FIG. 3, the line representing the fuel supply 42 experiences little pressure fluctuation. Similarly, the line representing the sac 41 also experiences little pressure fluctuation, especially in comparison to FIG. 4. However, pressure fluctuations internal to the injector body 11, such as at the nozzle chamber 22, experience large fluctuations, particularly when compared to FIG. 4 which represent the disclosed injectors 10 illustrated in FIGS. 1 and 2.

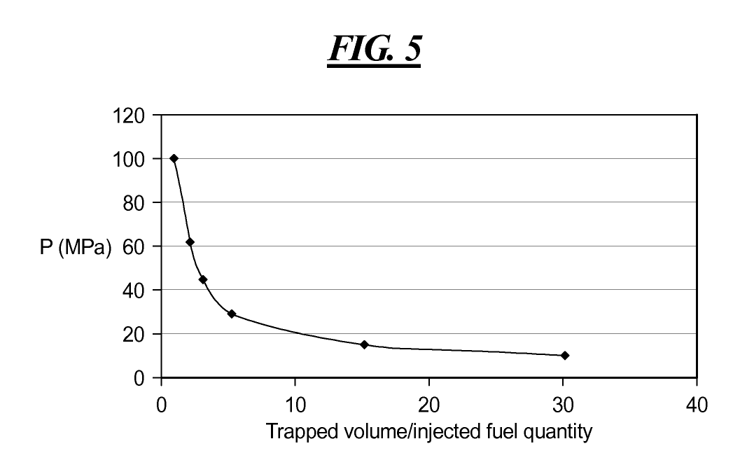

Thus, the use of an extended high pressure fuel line 21 in combination with a sizable nozzle chamber 22 creates a damping effect which reduces pressure oscillations. The combined volume of the nozzle chamber 22 and fuel line 21 should be substantially greater than the dispensed fuel volume. For example, if an injector volume is about 15 mL, the combined volume of the nozzle chamber 22 and fuel line 21 should preferably exceed 150 mL, more preferably greater than 300 mL and still more preferably from about 225 mL to about 450 mL. In terms of ratios, turning to FIG. 5, the ratio of the combined volume of the nozzle chamber 22 and the high pressure fuel line 21 over the injected fuel quantity is shown along the x-axis. Pressure is shown along the y-axis. As the pressure continues to drop as the ratio exceeds 10, the preferred ratio of the combined volume of the nozzle chamber and high pressure fuel line over the injected fuel quantity ranges from about 10 to about 30 and more preferably from about 15 to about 30.

### INDUSTRIAL APPLICABILITY

The disclosed fuel injector are applicable to engine running on HFO, diesel and gasoline where pressure overshoot, pressure oscillations and water hammer may present problems. The disclosed fuel injectors eliminate or substantially reduce the pressure overshoot, pressure oscillations and water hammer problem thereby increasing the useful life of the injectors. The problems associated with pressure oscillations, pressure overshoot and water hammer are addressed by recognizing that a reduction in pressure overshoot and oscillation can be achieved by optimizing the size and location of the nozzle chamber and high pressure fuel line. At high pressure, fuel in the nozzle chamber and high pressure fuel line can be thought of as a liquid spring where the liquids bulk modulus represents the spring rate and the liquids volume represents the spring mass. As a result, an effective damping of pressure overshoot is achieved.

A disclosed fuel injector configured to inject a predetermined volume of fuel includes an injector body defining a fuel inlet, a fuel passageway, and an orifice. A needle is disposed at least partially within the injector body or an attached nozzle tip, which may or may not form a part of the injector body. The needle is movable between a closed position where the needle blocks the orifice and an open position where the needle at least partially unblocks the orifice. At least the nozzle tip and the needle define a nozzle chamber. The nozzle chamber is in communication with the fuel passageway and the orifice. The fuel passageway and the nozzle chamber have a combined volume greater than the predetermined volume. Preferably, the combined volume is at least 10 times greater than the predetermined volume. More preferably, the combined volume is at least 15 times greater than the predetermined volume. Still more preferably, the combined volume of the nozzle chamber and high pressure fuel line ranges from about 15 to about 30 times the predetermined injection volume.

The fuel passageway may or may not have a substantially continuous diameter. The nozzle tip and needle may define the nozzle chamber that surrounds the needle and that is connected to the high pressure fuel passageway. In another aspect, the needle is coupled to a stop and a guide and the stop and guide are biased into a closed position by a spring. In another aspect, the injector body and stop form a clearance that enables the needle and control valve to move between the open and closed positions. As noted above, the disclosed fuel injector is particularly useful for injecting HFO, although it is applicable to both diesel and gasoline as well. When HFO is injected, it may have a bulk modulus of 3000 MPa or more at a pressure of about 200 MPa. The volume of fuel injected may vary greatly such as from about 10 to about 20 mL, more preferably from about 13 to about 17 mL.

A method for reducing pressure overshoot in a fuel injection system is also disclosed. The method includes providing an injector body and nozzle tip that define a fuel inlet, a fuel passageway, and an orifice. The method also includes providing a needle disposed at least partially within the nozzle tip. The needle is movable between a closed position where the needle blocks the orifice and an open position where the needle at least partially unblocks the orifice. The method also includes providing a nozzle chamber defined at least in part by the nozzle tip and the needle. The nozzle chamber is in communication with the fuel passageway and the orifice. The fuel passageway and nozzle chamber have a combined volume ranging from about 10 to about 30 times greater than the predetermined fuel dispense volume.

What is claimed is:

1. A fuel injector configured to inject a predetermined volume of fuel, the fuel injector comprising:
an injector body defining a fuel inlet, a fuel passageway, the injector body coupled to a nozzle tip that defines at least one orifice;
a needle disposed at least partially within the nozzle tip, the needle movable between a closed position where the needle blocks the orifice and an open position where the needle at least partially unblocks the orifice;
at least the injector body and needle defining a nozzle chamber, the nozzle chamber being in communication with the fuel passageway and the orifice;
the fuel passageway and the nozzle chamber having a combined volume greater than the predetermined injection volume.

2. The fuel injector of claim 1 wherein the combined volume is at least 10 times the predetermined injection volume.

3. The fuel injector of claim 1 wherein the combined volume is at least 15 times the predetermined injection volume.

4. The fuel injector of claim 1 wherein the combined volume ranges from about 15 to about 30 times the predetermined injection volume.

5. The fuel injector of claim 1, wherein the fuel passageway has a substantially continuous diameter.

6. The fuel injector of claim 1 wherein the nozzle tip and needle define the nozzle chamber that surrounds the needle and is connected to the fuel passageway.

7. The fuel injector of claim 1 wherein the needle is connected to a stop that limits movement of the needle away from the orifices.

8. The fuel injector of claim 1 wherein the stop is connected to a guide, the passing through a shim.

9. The fuel injector of claim 1 wherein the stop and shim form a clearance within the injector body that enables the needle and control valve to move between the open and closed positions.

10. The fuel injector of claim 1 wherein the fuel injector is configured to inject heavy fuel oil.

11. The fuel injector of claim 1 wherein the heavy fuel oil has a bulk modulus of at least 3000 MPa at a pressure of about 200 MPa.

12. The fuel injector of claim 1 wherein the predetermined volume ranges from about 10 to about 20 mL.

13. The fuel injector of claim 12 wherein the predetermined volume ranges from about 13 to about 17 mL.

14. A fuel injector configured to inject a predetermined volume of heavy fuel oil (HFO), the fuel injector comprising:
an injector body defining a fuel inlet and a fuel passageway;
the injector body being coupled to a nozzle tip that defines at least one orifice;
a needle disposed at least partially within the nozzle tip, the needle movable between a closed position where the needle blocks the orifice and an open position where the needle at least partially unblocks the orifice;
at least the nozzle tip and needle defining a nozzle chamber, the nozzle chamber being in communication with the fuel passageway and the orifice;
the fuel passageway and the nozzle chamber having a combined volume ranging from about 15 to about 30 times greater than the predetermined volume.

15. The fuel injector of claim 14 wherein the nozzle tip and needle define the nozzle chamber that surrounds the needle and is connected to the fuel passageway.

16. The fuel injector of claim 14 wherein the needle is connected to a stop that limits movement of the needle away from the orifices.

17. The fuel injector of claim 1 wherein the heavy fuel oil has a bulk modulus of at least 3000 MPa at a pressure of about 200 MPa.

18. The fuel injector of claim 17 wherein the predetermined volume ranges from about 13 to about 17 mL.

19. A method of reducing pressure overshoot in a fuel injection system, the method comprising:
providing an injector body defining a fuel inlet and a fuel passageway;
coupling a nozzle tip to the injector body that defines at least one orifice;
providing a needle disposed at least partially within the nozzle tip, the needle movable between a closed position where the needle blocks the orifice and an open position where the needle at least partially unblocks the orifice;
providing a nozzle chamber defined by at least the nozzle tip and needle, the nozzle chamber being in communication with the fuel passageway and the orifice;
providing a combined volume for the fuel passageway and the nozzle chamber that ranges from about 10 to about 30 times greater than the predetermined volume.

20. The method of claim 19 wherein the fuel injector is configured to inject heavy fuel oil having a bulk modulus of at least 3000 MPa at a pressure of about 200 MPa.
